(19) United States
(12) Patent Application Publication
(10) Pub. No.: US 2015/0278821 A1
(43) Pub. Date: Oct. 1, 2015

(54) SYSTEMS AND METHODS TO DELIVER AN ITEM

(71) Applicants: Ismael Ali Benhamida, Menlo Park, CA (US); Donald Evan Fultz, San Jose, CA (US); Kristine Chin Aronson, Los Altos, CA (US); Kevin Carvalho, Sunnyvale, CA (US)

(72) Inventors: Ismael Ali Benhamida, Menlo Park, CA (US); Donald Evan Fultz, San Jose, CA (US); Kristine Chin Aronson, Los Altos, CA (US); Kevin Carvalho, Sunnyvale, CA (US)

(21) Appl. No.: 14/227,852

(22) Filed: Mar. 27, 2014

(51) Int. Cl. G06Q 30/00

(52) U.S. Cl. CPC G06Q 30/012

(57) ABSTRACT

A system may receive a request to replace a first item purchased by a buyer from a user device operated by the buyer. The request may also include a geographical location of the user device. A second item to replace the first item may be identified based on the item characteristics of the first item. A provider located within a pre-defined distance from the geographic location of the user device may be determined as having the second item available to replace the first item. An option of delivering the second item from the provider to the buyer may be displayed.

### TECHNICAL FIELD

The subject matter disclosed herein generally relates to the processing of data. Specifically, the present disclosure addresses systems and methods to deliver an item.

### BACKGROUND

A buyer may purchase an item that is available for sale online from an item page created by a seller. However, when the seller ships the item to the buyer, the buyer may not be satisfied with the item for various reasons or the buyer may never receive the item. As a result, the buyer may submit a claim to obtain a refund for the purchase from the seller.

### BRIEF DESCRIPTION OF THE DRAWINGS

Some embodiments are illustrated by way of example and not limitation in the figures of the accompanying drawings.

FIG. 1 is a network diagram illustrating a network environment suitable for delivering an item, according to some example embodiments.

FIG. 2 is a block diagram illustrating components of a delivery machine, according to some example embodiments.

FIG. 3 is a user interface diagram of an option to receive a replacement item, according to some example embodiments.

FIG. 4 is a user interface diagram of an option to receive a replacement item, according to some example embodiments.

FIG. 5 is a user interface diagram of an option to return an original item to a seller, according to some example embodiments.

FIG. 6 is a user interface diagram that tracks delivery of a replacement item, according to some example embodiments.

FIGS. 7 and 8 are flowcharts illustrating operations of a delivery machine in performing a method displaying an option to deliver an item, according to some example embodiments.

FIG. 9 is a block diagram illustrating components of a machine, according to some example embodiments, able to read instructions from a machine-readable medium and perform any one or more of the methodologies discussed herein.

### DETAILED DESCRIPTION

Example methods and systems are directed to delivery of an item. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

A buyer may purchase an item that is listed online in an item page from a seller of the item. However, often times the buyer may not be satisfied with the item that is shipped to the buyer. Various reasons can contribute to this friction. For instance, a description of the item from the item page may not accurately portray the item. As another example, the seller may have accidentally shipped a wrong item to the buyer. A system can be implemented to assist the buyer by offering a service of delivering a replacement item to the buyer. The further item can be used to replace the original item. In some instances, this can also relieve a burden on behalf of the buyer to make a claim for a refund on the purchased item. Therefore, rather than having the buyer submit a claim to obtain a refund on the purchased item, the system can present to the buyer with an option of having the further item shipped to the buyer. Moreover, the system may present to the buyer a service that delivers the original item back to the seller.

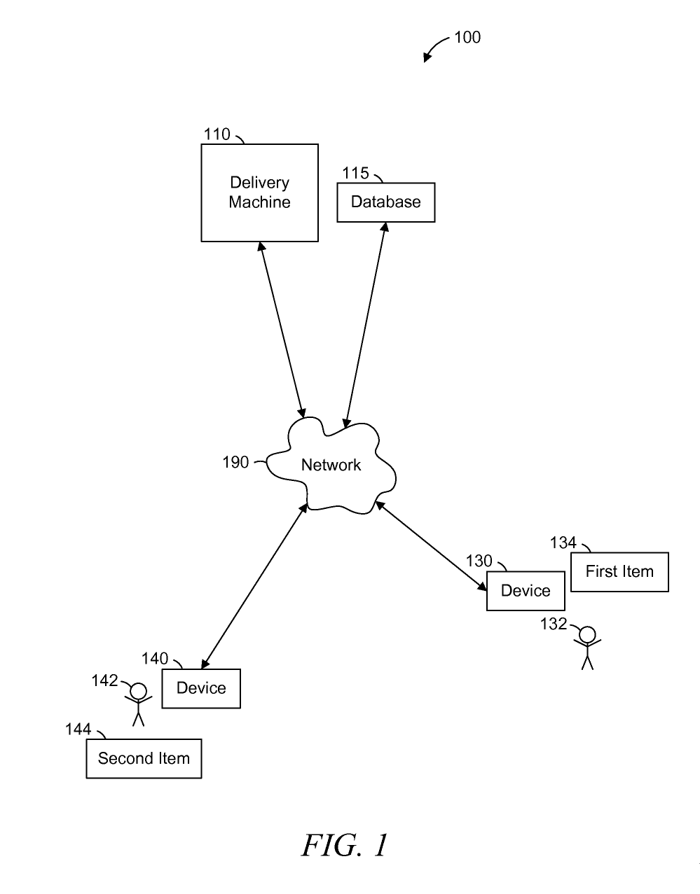

FIG. 1 is a network diagram illustrating a network environment 100 suitable for delivering an item, according to some example embodiments. The network environment 100 includes a delivery machine 110, a database 115, and devices 130 and 140, all communicatively coupled to each other via a network 190.

Also shown in FIG. 1 are users 132 and 142. One or both of the users 132 and 142 may be a human user (e.g., a human being), a machine user (e.g., a computer configured by a software program to interact with the device 130), or any suitable combination thereof (e.g., a human assisted by a machine or a machine supervised by a human). The user 132 is not part of the network environment 100, but is associated with the device 130 and may be a user of the device 130. For example, the device 130 may be a desktop computer, a vehicle computer, a tablet computer, a navigational device, a portable media device, or a smart phone belonging to the user 132. Likewise, the user 142 is not part of the network environment 100, but is associated with the device 140. As an example, the device 140 may be a desktop computer, a vehicle computer, a tablet computer, a navigational device, a portable media device, or a smart phone belonging to the user 142.

The user 132 may have purchased a first item 134 from a seller of the first item via the network 190. The user 132 may submit a request to the delivery machine 110 indicating that the user 132 is not satisfied with the first item 134. In response, the delivery machine 110 may locate a provider (e.g., user 142) that has a second item 144 available that may be used to replace the first item 134. The delivery machine 110 may then present to the user 132 an option of having the provider deliver the second item 144 directly to the user 132.

Any of the machines, databases, or devices shown in FIG. 1 may be implemented in a general-purpose computer modified (e.g., configured or programmed) by software to be a special-purpose computer to perform one or more of the functions described herein for that machine, database, or device. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines, databases, and devices (e.g., the delivery machine 110 and the device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 190 may communicate information via a transmission medium. As used herein, “transmission medium” shall be taken to include any intangible medium that is capable of storing, encoding, or carrying instructions for execution by a machine, and includes digital or analog communication signals or other intangible media to facilitate communication of such software.

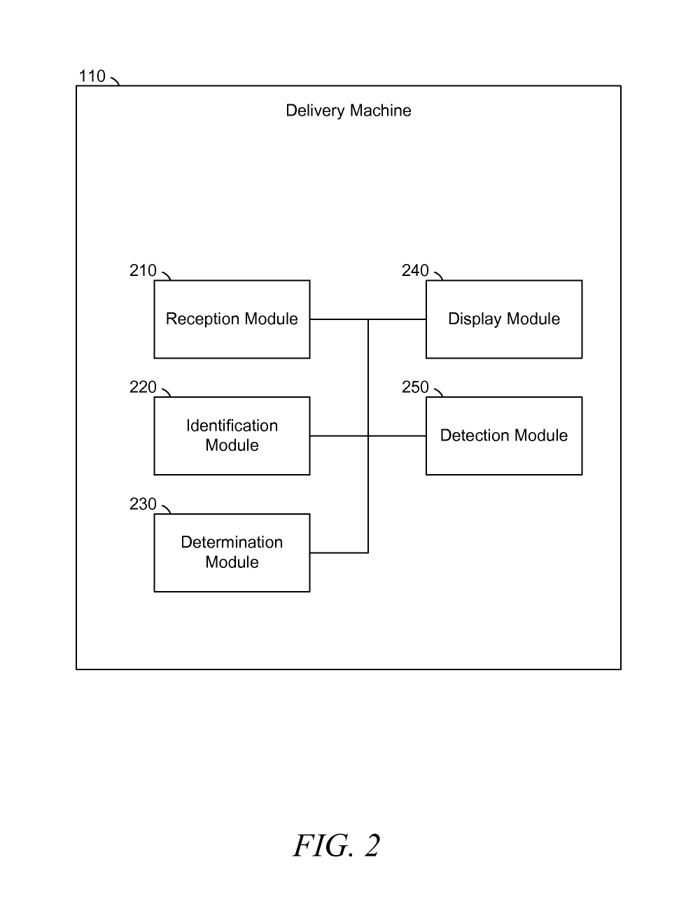

FIG. 2 is a block diagram illustrating components of the delivery machine 110, according to some example embodiments. The delivery machine 110 is shown as including a reception module 210, an identification module 220, a determination module 230, a display module 240, and a detection module 250, all configured to communicate with each other (e.g., via a bus, shared memory, or a switch). Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

In various example embodiments, the reception module 210 is configured to receive a request to replace a first item purchased by a buyer from an item page created for the first item by a seller. The request may be received from a user device operated by the buyer. Moreover, the request may also include a geographical location of the user device. In various example embodiments, the reception module 210 is further configured to receive preferences of the buyer from the user device operated by the buyer. The preferences of the buyer may indicate item characteristics that are of interest to the buyer. Item characteristics of interest to the buyer may include preferences for: a color of an item, a type of item, brand of an item, specifications of an item, dimensions of an item, aesthetic qualities of an item, or any suitable combination thereof. In various example embodiments, the reception module 210 is further configured to receive an address of the buyer. The address of the buyer may be a shipping address at which a second item may be shipped to the buyer. Moreover, the second item may be used to replace the first item. In various example embodiments, the reception module 210 is further configured to receive a selection of an option of delivering the second item from the provider to the buyer. The option may be displayed on the user device, as further explained below. Upon receiving the selection, the detection module 250 is further configured to track the delivery of the second item, as further explained below.

In various example embodiments, the identification module 220 is configured to identify the second item to replace the first item based on the item characteristics of the first item. In some instances, identification module 220 may identify a match between item characteristics of the second item with the item characteristics of the first item. For instance, the buyer may purchase a first item that later becomes defective and the identification module 220 may identify a second item is similar or identical to the first item which can be used to replace the defective first item. In various example embodiments, the identification module 220 may determine that the second item is more compatible with the preferences of the buyer than the first item. For instance, the second item may have item characteristics that match the preferences of the buyer. As an example, the second item may be associated with a brand of interest to the buyer. As another example, the second item may be in a color that the buyer prefers. In some instances, the buyer may have been dissatisfied with the first item because the seller may have shipped an incorrect item to the buyer (e.g., 8 megabyte flash drive instead of a 16 megabyte flash drive). As a result, the identification module 220 may identify that the second item can be used to replace the first item and correct the seller's mistake. In various example embodiments, the identification module 220 is further configured to identify the second item to replace the first item in response to the detection module 250 detecting an inconsistency with regards to the item page of the first item and the delivered first item, as further explained below.

In various example embodiments, the determination module 230 is configured to determine that a provider located within a pre-defined distance from the geographic location of the user device has the second item to replace the first item. Moreover, the determination module 230 may calculate the pre-defined distance when the buyer submits the request to replace the first item. In some instances, the pre-defined distance is an area within a certain radius from the location of the user device. The provider may be another seller or retailer other than the seller from which the buyer purchased the first item. For example, the provider may be merchant operating out of a brick-and-mortar store. A brick-and-mortar store may include a physical retail location carrying merchandise item available for sale. In some instances, the determination module 230 may access a profile of the provider. The profile of the provider may indicate reliability of the provider with regards to previous customers. The profile of the provider may also indicate ratings of the provider received from the previous customers. The profile of the provider may also indicate whether the second item is included in an item inventory of the provider. As a result, the determination module 230 may determine that the provider has the second item to replace the first item based on the profile of the provider. As an example, the determination module 230 may determine that the provider has the second item included in the item inventory and therefore may determine that the provider has the second item to replace the first item. As another example instance, the profile of the provider may indicate favorable ratings for the provider. The determination module 230 may be further configured to select the provider as being the provider of the second item based on the favorable ratings indicated in the profile of the provider. In various example embodiments, the determination module 230 may select the provider further based on determining the provider as being within a pre-defined distance from the geographic location of the user device when the buyer submits the request to replace the first item via the user device. In various example embodiments, the determination module 230 is further configured to determine a number of other providers that have the second item in stock to replace the first item.

In various example embodiments, the display module 240 is configured to display an option of delivering the second item from the provider to the buyer in response to the determination module 230 determining that the provider has the second item to replace the first item. The option to have the second item delivered may be displayed on the user device of the buyer. Moreover, the buyer may select the option in order to have the second item delivered from the provider to the buyer. Upon selecting the option to have the second item delivered, provider may deliver the second item to the buyer through various courier services. The courier service may include the United States Postal Service, Fed Ex, or any other service capable of delivering the second item to the buyer. In some instances, the provider has its own courier service which may be used to deliver the second item. The display module 240 may be further configured to display an option of returning the first item to the seller of the first item via delivery of the first item by a courier. For example, the display module 240 may allow the buyer to select an option that would have a courier service return the first item returned to the seller. The courier service may include the United States Postal Service, Fed Ex, or any other service capable of shipping the first item back to the seller. In various example embodiments, the display module 240 may be further configured to display an option of returning the first item to the provider of the second item. Moreover, the provider of the second item may act as a courier to return the first item back to the seller. Alternatively, the provider may sell the first item and use the profits to pay the seller of the first item. In various example embodiments, the display module 240 may be further configured to generate a shipping label that is addressed to the seller of the first item. Moreover, the display module 240 may display the generated shipping label addressed to the seller of the first item. The buyer may use the shipping label displayed on the user device to ship the first item back to the seller. For example, the buyer may print out the shipping label displayed on the user device. In some instances, the provider is a merchant operating out of a brick-and-mortar store. The display module 240 may be further configured to display an address of the brick-and-mortar store to the device operated by the buyer. This information may enable the buyer to physically travel to the brick-and-mortar store and retrieve the second item from the brick-and-mortar store. As such, the display module 240 may display an option of having the buyer pick up the second item from a pick-up location. The address of the brick-and-mortar store can also be changed at any time. In various example embodiments, the display module 240 displays the option of delivering the second item from the provider to the buyer based on the number of other providers that have the second item to replace the first item, as determined by the determination module 230. The determination module 230 may determine that a threshold number of other providers have the second item to replace the first item. In response, the display module 240 may display the option based on the determination by the determination module 230 that the threshold number of other providers have the second item available in stock. In some instances, the display module 240 may display the option of delivering the second item based on a transaction history of the buyer. The transaction history of the buyer may be stored in a buyer profile of the buyer. The transaction history may indicate that the buyer is reliable and has no record of fraudulent claims. As a result, the display module 240 may display the option of delivering the second item based on determining that the buyer is reliable. In some instances, the display module 240 may display the option of delivering the second item based on a calendar date. For instance, if the current calendar date is close to Christmas time, then the display module 240 may display the option of delivering the second item. In some instances, the display module 240 may send the address of the buyer to the provider of the second item in order to facilitate delivery of the second item to the address of the buyer. The provider may use the address to ship the second item to the address of the buyer. Moreover, the display module 240 may display the option of delivering the second item based on the address of the buyer. In some instances, the display module 240 may display the option of delivering the second item based on the item characteristics of the second item. For example, if the second item is expensive, then the display module 240 may delay displaying the option of delivering the second item. Whereas if the second item is inexpensive, then the display module 240 may immediately display the option of delivering the second item. In some instances, the condition of the second item must exceed pre-defined threshold prior to the display module 240 displaying the option of delivering the second item.

In various example embodiments, the detection module 250 is configured to detect an inconsistency between at least one of the item characteristics of the first item and a corresponding description of the at least one item characteristics of the first item included in the item page for the first item. In other words, the detection module 250 can detect that the description of the item is inaccurate with regards to the item characteristics. For example, the item listing may describe a 12 megabyte flash disk when in reality an 8 megabyte flash disk is shipped to the buyer. As a result, the detection module 250 may also be used to detect that an error has been made with regards to the shipment of the first item. In response to the error being detected, the identification module 220 may identify the second item to replace the first item, as explained above. In various example embodiments, the detection module 250 is further configured to track delivery of the second item to the buyer. For instance, delivery of the second item to the buyer may occur in a series of stages and the detection module 250 may detect when each stage of delivery is completed.

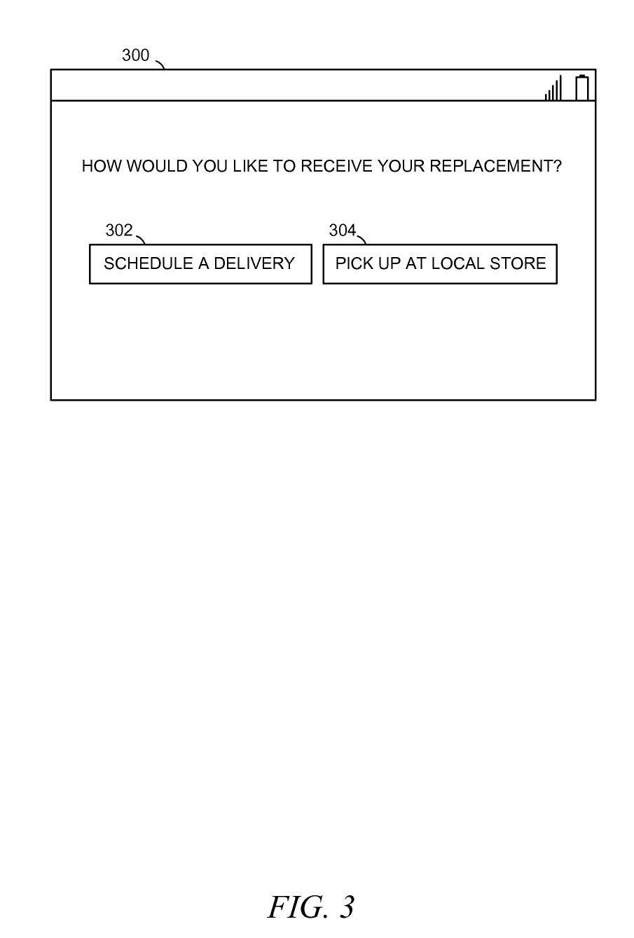

FIG. 3 is a user interface diagram 300 of an option to receive a replacement item, according to some example embodiments. The user interface diagram 300 may be displayed in a mobile device belonging to a buyer of an item that needs replacement. The user interface diagram 300 may include an option 302 to have a replacement item delivered to the buyer. Further, the user interface diagram 300 may include an option 304 to have the buyer pick up the replacement item at pick up location, such as a local store. The buyer may choose either option 302 or option 304 as a method of obtaining the replacement item. As sated previously, upon selecting the option to have the replacement item delivered, a provider of the replacement item may deliver the replacement item to the buyer through various courier services. The courier service may include the United States Postal Service, Fed Ex, or any other service capable of delivering the replacement item to the buyer.

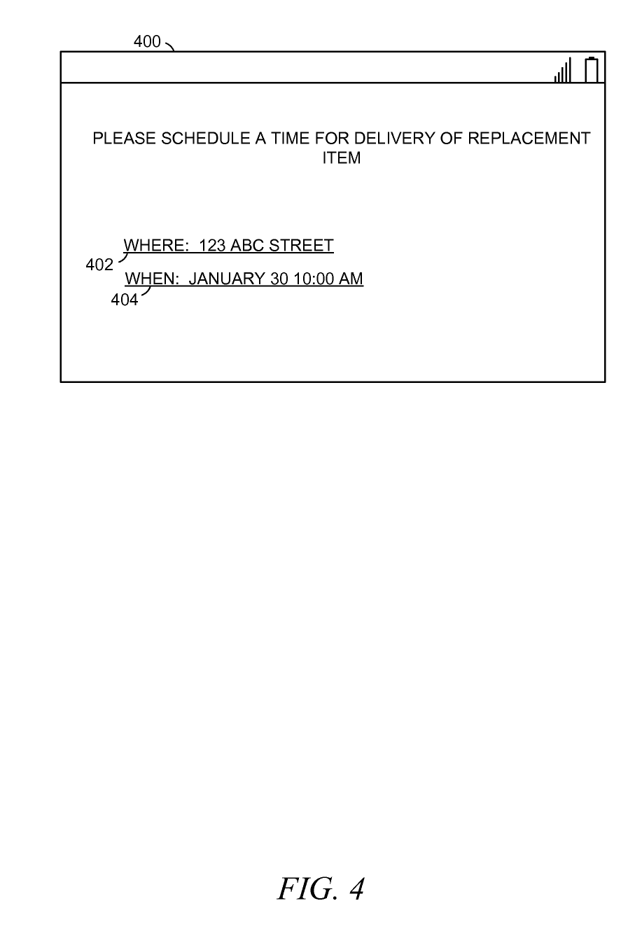

FIG. 4 is a user interface diagram 400 of an option to receive a replacement item, according to some example embodiments. In various example embodiments, the user interface diagram 400 is displayed on a mobile device of a buyer after the buyer selects option 302 in FIG. 3. Upon selecting option 302, the buyer may specify an address 402 of where the replacement item is to be delivered. The buyer may also specify a time 404 of delivery for the replacement item.

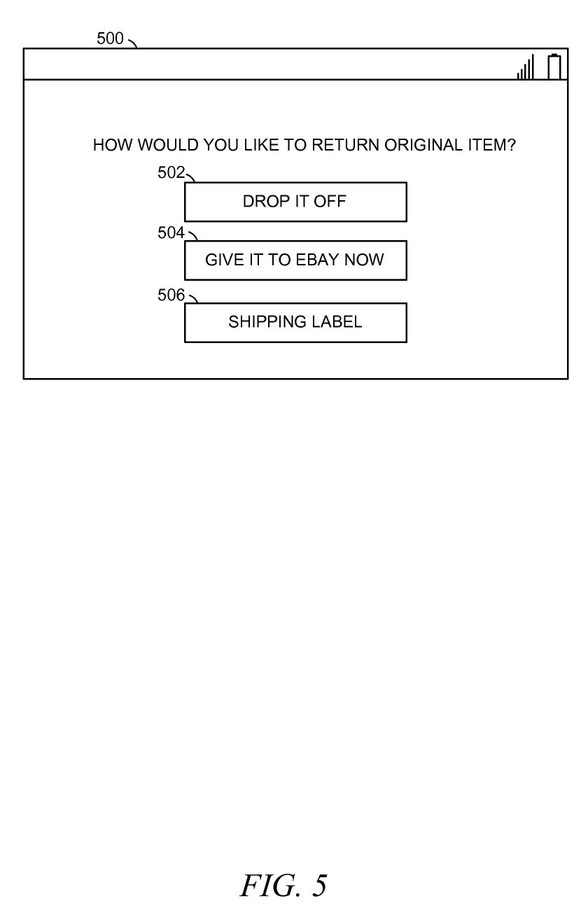

FIG. 5 is a user interface diagram 500 of an option to return an original item to a seller, according to some example embodiments. In various example embodiments, the user interface diagram 500 may be displayed on a mobile device of a buyer. The user interface diagram 500 may include an option 502 of dropping off an item that is to be replaced, an option 504 of having the item delivered back to an original seller of the item via a courier service, and an option 506 of having a shipping label generated which can be used to ship the original item back to the original seller.

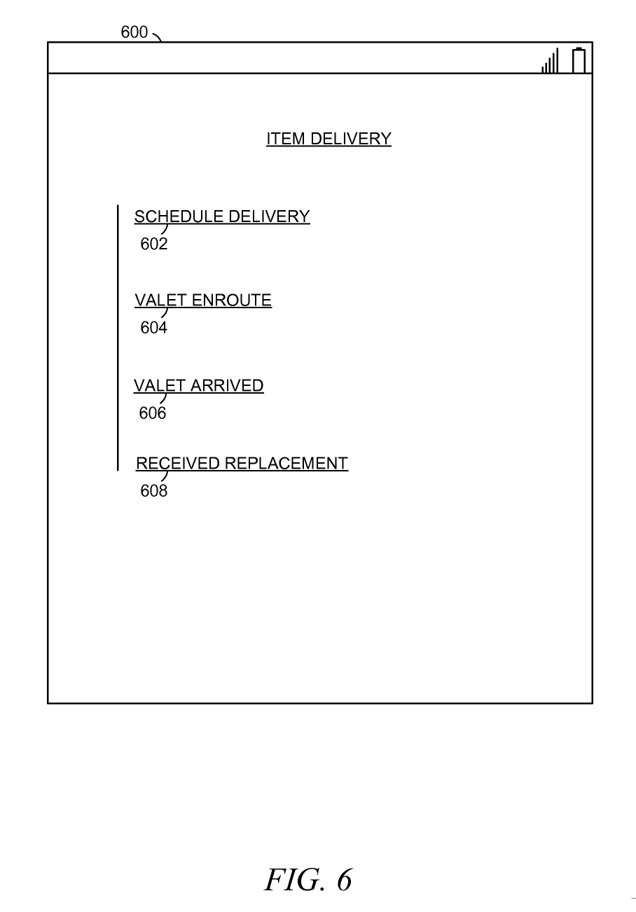

FIG. 6 is a user interface diagram 600 that tracks delivery of a replacement item, according to some example embodiments. The user interface diagram 600 may display stages 602, 604, 606, and 608 of the delivery of the replacement item. Moreover, each of the stages 602, 604, 606, and 608 may be highlighted as soon as they are detected by the detection module 250 as being completed. A first stage 602 may correspond to a delivery of the replacement item being scheduled. A second stage 604 may correspond to the replacement item being delivered by a courier service. A third stage 606 may correspond to the replacement item arriving at an address of the buyer. Lastly, a fourth stage 608 may correspond to confirmation of the buyer receiving the replacement item.

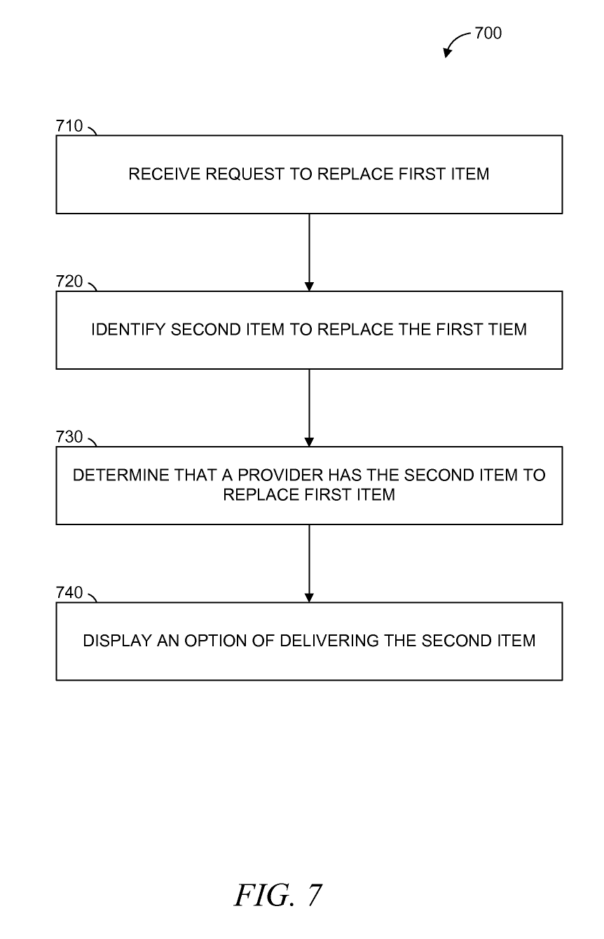

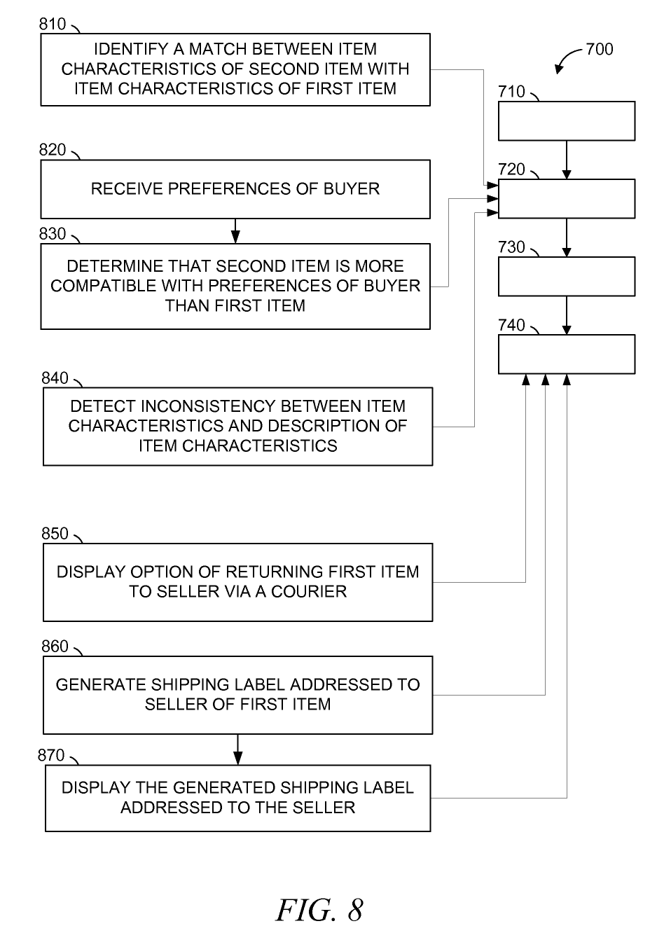

FIGS. 7 and 8 are flowcharts illustrating operations of the delivery machine 110 in performing a method 700 of displaying an option of delivering an item, according to some example embodiments. Operations in the method 700 may be performed by the delivery machine 110, using modules described above with respect to FIG. 2. As shown in FIG. 7, the method 700 includes operations 710, 720, 730, and 740.

At operation 710, the reception module 210 may receive a request to replace a first item purchased by a buyer from an item page created for the first item by a seller.

At operation 720, the identification module 220 may identify a second item to replace the first item based on the item characteristics of the first item.

At operation 730, the determination module 230 may determine that a provider located within a pre-defined distance from the geographic location of the user device has the second item available to replace the first item.

At operation 740, the display module 240 may display an option of delivering the second item from the provider to the buyer in response to the determination module 230 determining that the provider has the second item to replace the first item at operation 730.

As shown in FIG. 8, the method 700 may include one or more of operations 810, 820, 830, 840, 850, 860, and 870.

At operation 810, the identification module 220 may identify a match between item characteristics of the second item with the item characteristics of the first item.

At operation 820, the reception module 210 may receive preferences of the buyer from the user device operated by the buyer.

At operation 830, the identification module 230 may determine that the second item is more compatible with the preferences of the buyer than the first item.

At operation 840, the detection module 250 may detect an inconsistency between at least one of the item characteristics of the first item and a corresponding description of the at least one item characteristics of the first item included in the item page for the first item.

At operation 850, the display module 240 may display an option of returning the first item to the seller of the first item via delivery of the first item by a courier.

At operation 860, the display module 240 may generate a shipping label addressed to the seller of the first item.

At operation 870, the display module 240 may display the generated shipping label addressed to the seller of the first item.

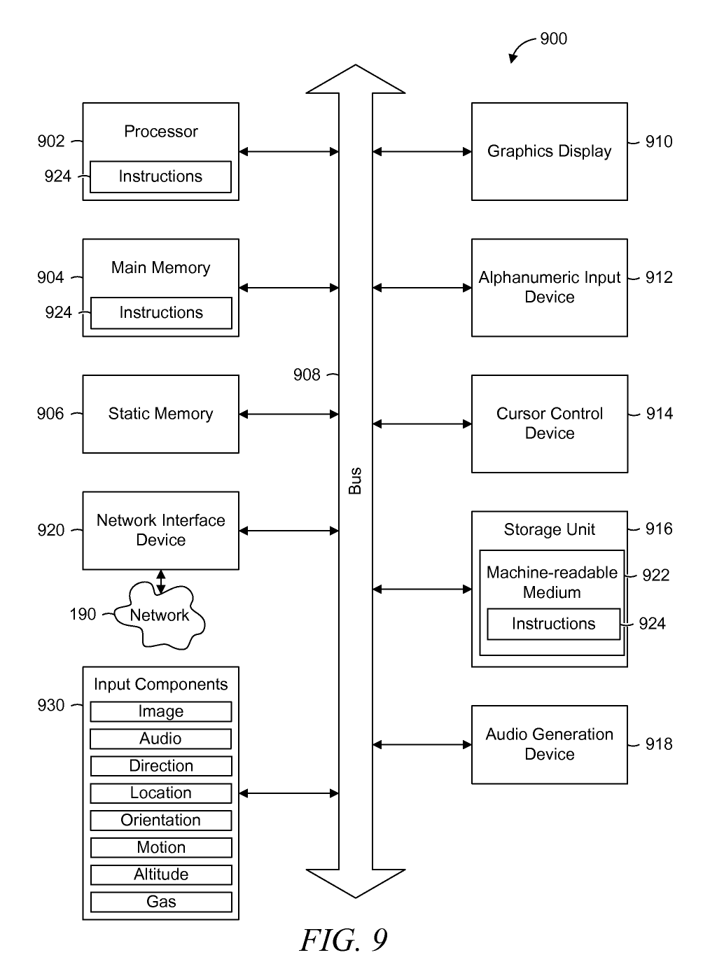

FIG. 9 is a block diagram illustrating components of a machine 900, according to some example embodiments, able to read instructions 924 from a machine-readable medium 922 (e.g., a machine-readable storage medium, a computer-readable storage medium, or any suitable combination thereof) and perform any one or more of the methodologies discussed herein, in whole or in part. Specifically, FIG. 9 shows the machine 900 in the example form of a computer system within which the instructions 924 (e.g., software, a program, an application, an applet, an app, or other executable code) for causing the machine 900 to perform any one or more of the methodologies discussed herein may be executed, in whole or in part. In alternative embodiments, the machine 900 operates as a standalone device or may be connected (e.g., networked) to other machines. In a networked deployment, the machine 900 may operate in the capacity of a delivery machine or a client machine in a server-client network environment, or as a peer machine in a distributed (e.g., peer-to-peer) network environment. The machine 900 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 924, sequentially or otherwise, that specify actions to be taken by that machine. Further, while only a single machine is illustrated, the term “machine” shall also be taken to include any collection of machines that individually or jointly execute the instructions 924 to perform all or part of any one or more of the methodologies discussed herein.

The machine 900 includes a processor 902 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 904, and a static memory 906, which are configured to communicate with each other via a bus 908. The processor 902 may contain microcircuits that are configurable, temporarily or permanently, by some or all of the instructions 924 such that the processor 902 is configurable to perform any one or more of the methodologies described herein, in whole or in part. For example, a set of one or more microcircuits of the processor 902 may be configurable to execute one or more modules (e.g., software modules) described herein.

The machine 900 may further include a graphics display 910 (e.g., a plasma display panel (PDP), a light emitting diode (LED) display, a liquid crystal display (LCD), a projector, a cathode ray tube (CRT), or any other display capable of displaying graphics or video). The machine 900 may also include an alphanumeric input device 912 (e.g., a keyboard or keypad), a cursor control device 914 (e.g., a mouse, a touchpad, a trackball, a joystick, a motion sensor, an eye tracking device, or other pointing instrument), a storage unit 916, an audio generation device 918 (e.g., a sound card, an amplifier, a speaker, a headphone jack, or any suitable combination thereof), and a network interface device 920.

The storage unit 916 includes the machine-readable medium 922 (e.g., a tangible and non-transitory machine-readable storage medium) on which are stored the instructions 924 embodying any one or more of the methodologies or functions described herein. The instructions 924 may also reside, completely or at least partially, within the main memory 904, within the processor 902 (e.g., within the processor's cache memory), or both, before or during execution thereof by the machine 900. Accordingly, the main memory 904 and the processor 902 may be considered machine-readable media (e.g., tangible and non-transitory machine-readable media). The instructions 924 may be transmitted or received over the network 190 via the network interface device 920. For example, the network interface device 920 may communicate the instructions 924 using any one or more transfer protocols (e.g., hypertext transfer protocol (HTTP)).

In some example embodiments, the machine 900 may be a portable computing device, such as a smart phone or tablet computer, and have one or more additional input components 930 (e.g., sensors or gauges). Examples of such input components 930 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 922 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 924 for execution by the machine 900, such that the instructions 924, when executed by one or more processors of the machine 900 (e.g., processor 1102), cause the machine 900 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
receiving a request to replace a first item purchased by a buyer from an item page created for the first item by a seller, the request received from a user device operated by the buyer and including a geographical location of the user device;
identifying, using a processor of a machine, a second item to replace the first item based on item characteristics of the first item;
determining that a provider located within a pre-defined distance from the geographic location of the user device has the second item available to replace the first item; and
displaying an option of delivering the second item from the provider to the buyer in response to the determination that the provider has the second item to replace the first item.

2. The method of claim 1, wherein the determining that the provider has the second item to replace the first item is based on a profile of the provider.

3. The method of claim 1, wherein the identifying the second item to replace the first item includes identifying a match between item characteristics of the second item with the item characteristics of the first item.

4. The method of claim 1, further comprising:
receiving preferences of the buyer from the user device operated by the buyer, and wherein the identifying the second item to replace the first item includes determining that the second item is more compatible with the preferences of the buyer than the first item.

5. The method of claim 1, further comprising:
detecting an inconsistency between at least one of the item characteristics of the first item and a corresponding description of the at least one item characteristics of the first item included in the item page, and wherein the identifying the second item to replace the first item is performed in response to detecting the inconsistency.

6. The method of claim 1, further comprising:
displaying an option of returning the first item to the seller of the first item via delivery of the first item by a courier.

7. The method of claim 6, further comprising:
generating a shipping label addressed to the seller of the first item and wherein the displaying the option of returning the first item to the seller of the first item includes displaying the generated shipping label.

8. The method of claim 1, wherein the provider is a merchant operating out of a brick-and-mortar store, and wherein the displaying the option includes displaying an address of the brick-and-mortar store where the second item is available to be retrieved.

9. The method of claim 1, further comprising:
determining that a number of other providers that have the second item to replace the first item exceeds a threshold value, wherein the displaying the option of delivering the second item performed in response to the determination that the number of other providers exceeds the threshold value.

10. The method of claim 1, wherein the displaying the option of delivering the second item is further based on buyer characteristics stored in a buyer profile of the buyer.

11. The method of claim 1, wherein the displaying the option of delivering the second item from the provider to the buyer is further based on a calendar date.

12. The method of claim 1, wherein the displaying the option of delivering the second item from the provider to the buyer is further based on item characteristics of the second item.

13. The method of claim 1, further comprising:
receiving an address of the buyer; and
sending the address of the buyer to the provider of the second item in order to facilitate delivery of the second item to the address of the buyer.

14. A system comprising:
a processor having:
a reception module configured to receive a request to replace a first item purchased by a buyer from an item page created for the first item by a seller, the request received from a user device operated by the buyer and including a geographical location of the user device;
an identification module configured to identify a second item to replace the first item based on item characteristics of the first item;
a determination module configured to determine that a provider located within a pre-defined distance from the geographic location of the user device has the second item available to replace the first item; and
a display module configured to display an option of delivering the second item from the provider to the buyer in response to the determination that the provider has the second item to replace the first item.

15. The system of claim 14, wherein the determination module is further configured to determine that the provider has the second item to replace the first item based on a profile belonging to the provider.

16. The system of claim 14, wherein the identification module is further configured to identify a match between item characteristics of the second item with the item characteristics of the first item.

17. The system of claim 14, wherein the reception module is further configured to receive preferences of the buyer from the user device operated by the buyer, and wherein the identification module is further configured to determine that the second item is more compatible with the preferences of the buyer than the first item.

18. The system of claim 14, further comprising:
a detection module configured to detect an inconsistency between at least one of the item characteristics of the first item and a corresponding description of the at least one item characteristics of the first item included in the item page, and wherein identification module is further configured to identify the second item to replace the first item in response to the detection module detecting the inconsistency.

19. The system of claim 14, wherein the display module is further configured to display an option of returning the first item to the seller of the first item via delivery of the first item by a courier.

20. A non-transitory machine-readable medium storing instructions that, when executed by one or more processors of a machine, cause the machine to perform operations comprising:
receiving a request to replace a first item purchased by a buyer from an item page created for the first item by a seller, the request received from a user device operated by the buyer and including a geographical location of the user device;
identifying a second item to replace the first item based on item characteristics of the first item;
determining that a provider located within a pre-defined distance from the geographic location of the user device has the second item available to replace the first item; and
displaying an option of delivering the second item from the provider to the buyer in response to the determination that the provider has the second item to replace the first item.
